(19) United States
(12) Patent Application Publication
(10) Pub. No.: US 2022/0261279 A1
(43) Pub. Date: Aug. 18, 2022

(54) STORAGE MEDIUM, INFORMATION PROCESSING APPARATUS, AND MULTIPLE CONTROL METHOD

(71) Applicant: FUJITSU LIMITED, Kawasaki-shi (JP)

(72) Inventors: Takahisa SUZUKI, Yokohama (JP); Ryuichi MATSUKURA, Kawasaki (JP); Miho KAWANO, Hamamatsu (JP); Shinya TOYONAGA, Kawasaki (JP)

(73) Assignee: FUJITSU LIMITED, Kawasaki-shi (JP)

(21) Appl. No.: 17/528,310

(22) Filed: Nov. 17, 2021

(30) Foreign Application Priority Data
Feb. 16, 2021 (JP) 2021-22593

(51) Int. Cl. G06F 9/48

(52) U.S. Cl. CPC G06F 9/4881

(57) ABSTRACT

A non-transitory computer-readable storage medium storing a multiple control program that causes at least one computer to execute a process, the process includes, storing a processing time of a first step in processes of a plurality of applications as a first threshold in a storage unit when the processes are executed in an overlapping manner; and when receiving an execution request from a subsequent application during execution of a process of the plurality of applications, delaying start of a process of the subsequent application by the first threshold or more from start of a process of a preceding application being executed.

### CROSS-REFERENCE TO RELATED APPLICATION

This application is based upon and claims the benefit of priority of the prior Japanese Patent Application No. 2021-22593, filed on Feb. 16, 2021, the entire contents of which are incorporated herein by reference.

### FIELD

The embodiments discussed herein are related to a storage medium storing a multiple control program, an information processing apparatus, and a multiple control method.

### BACKGROUND

In recent years, systems that execute artificial intelligence (AI) processing using a graphical processing unit (GPU) have been increasing. For example, there is a system that performs object detection or the like by AI processing of a video.

In such a system, one GPU processes videos transferred from one camera. However, since the videos are sent at regular intervals, time when the GPU is not used is generated between pieces of processing. It is expected that one GPU accommodates and processes videos transferred from a plurality of cameras so that the time when the GPU is not used is not generated and the GPU is efficiently used.

Japanese Laid-open Patent Publication No. 2020-109890, Japanese Laid-open Patent Publication No. 2020-135061, and Japanese Laid-open Patent Publication No. 2019-175292 are disclosed as related art.

### SUMMARY

According to an aspect of the embodiments, a non-transitory computer-readable storage medium storing a multiple control program that causes at least one computer to execute a process, the process includes, storing a processing time of a first step in processes of a plurality of applications as a first threshold in a storage unit when the processes are executed in an overlapping manner; and when receiving an execution request from a subsequent application during execution of a process of the plurality of applications, delaying start of a process of the subsequent application by the first threshold or more from start of a process of a preceding application being executed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a functional configuration of a system including an execution server according to a first embodiment;

FIG. 2A is a diagram (1) for describing multiple control according to the first embodiment;

FIG. 2B is a diagram (2) for describing multiple control according to the first embodiment;

FIG. 3 is a diagram illustrating an example of a functional configuration of a GPU use control unit according to the first embodiment;

FIG. 4 is a diagram illustrating an example of profile information according to the first embodiment;

FIG. 5 is a diagram illustrating an example of a data structure of a request queue;

FIG. 6 is a diagram illustrating an example of a hardware configuration of the execution server;

FIG. 7 is a diagram illustrating an example of a flowchart of delay execution determination processing according to the first embodiment;

FIG. 8 is a diagram illustrating an example of a flowchart of delay-waiting request management processing according to the first embodiment;

FIG. 9 is a diagram illustrating an example of a flowchart of use request transmission processing according to the first embodiment;

FIG. 10 is a diagram illustrating an example of a flowchart of processing result transmission destination determination processing according to the first embodiment;

FIG. 11 is a diagram illustrating an example of a functional configuration of a GPU use control unit according to a second embodiment;

FIG. 12 is a diagram illustrating an example of profile information according to the second embodiment;

FIG. 13 is a diagram illustrating an example of a flowchart of delay execution determination processing according to the second embodiment;

FIG. 14 is a diagram illustrating an example of a flowchart of delay-waiting request management processing according to the second embodiment;

FIG. 15 is a diagram illustrating an example of a functional configuration of a GPU use control unit according to a third embodiment;

FIG. 16 is a diagram illustrating an example of profile information according to the third embodiment;

FIG. 17 is a diagram illustrating an example of a flowchart of delay execution determination processing according to the third embodiment;

FIG. 18 is a diagram illustrating an example of a flowchart of delay-waiting request management processing according to the third embodiment;

FIG. 19 is a diagram illustrating an example of a flowchart of use request transmission processing according to the third embodiment;

FIG. 20 is a diagram illustrating an example of a flowchart of processing result transmission destination determination processing according to the third embodiment;

FIG. 21 is a diagram illustrating an example of use of multiple control according to the first to third embodiments; and

FIG. 22 is a diagram for describing an increase in processing time due to interference between processes.

### DESCRIPTION OF EMBODIMENTS

When one GPU processes a plurality of videos, in some cases, a plurality of processes are executed by one GPU in an overlapping manner. In such cases, there is a problem in which processing time increases due to interference between the processes.

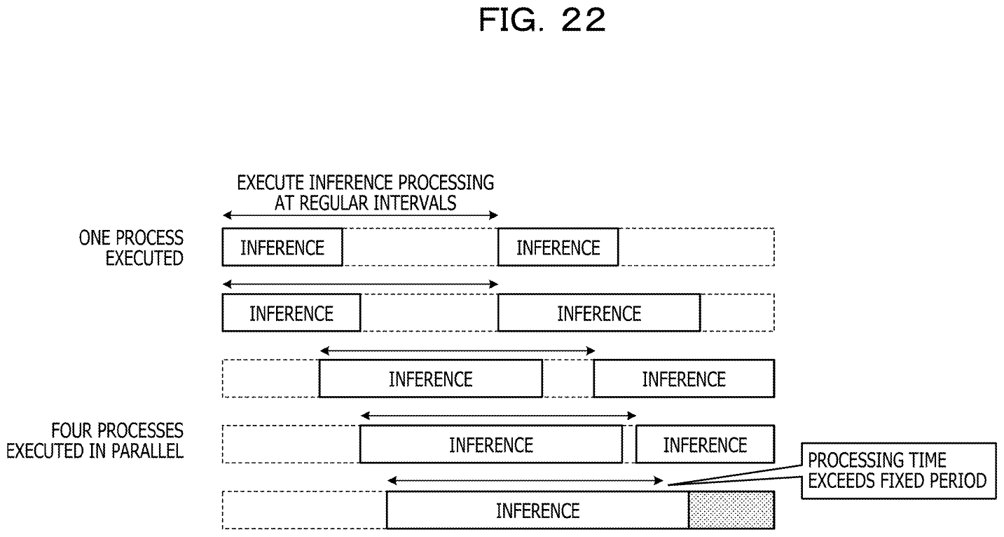

A case in which processing time increases due to interference between processes will be described with reference to FIG. 22. FIG. 22 is a diagram for describing an increase in processing time due to interference between processes. As illustrated in FIG. 22, one GPU may process a plurality of tasks in an overlapping manner. In this case, inference processing of videos is illustrated as the processing of a task, and four processes are executed in parallel.

When a GPU executes one process for inference processing of videos, the GPU executes inference processing at predetermined regular intervals. However, when the GPU executes four processes in parallel for inference processing of videos, pieces of inference processing may interfere with each other, causing an increase in processing time. The degree of increase in processing time varies depending on the details of the inference processing and the manner of overlapping. For example, the degree of increase in processing time is larger when the overlap between pieces of inference processing is larger and the number of overlapping pieces of inference processing is larger. Since the start timings of inference processing are different from each other, when many pieces of inference processing happen to start at close timings, the number of overlapping pieces of inference processing increases, the degree of increase in processing time increases, and the processing time of inference processing exceeds a fixed period. For example, there arises a problem in which processing time increases due to interference between processes.

In one aspect, an object of the present disclosure is to suppress an increase in processing time due to overlapping execution of processes even when one GPU executes a plurality of processes in an overlapping manner.

Hereinafter, the embodiments of a multiple control program, an information processing apparatus, and a multiple control method disclosed in the present application will be described in detail with reference to the drawings. The present disclosure is not limited by the embodiments.

### First Embodiment

[Configuration of System]

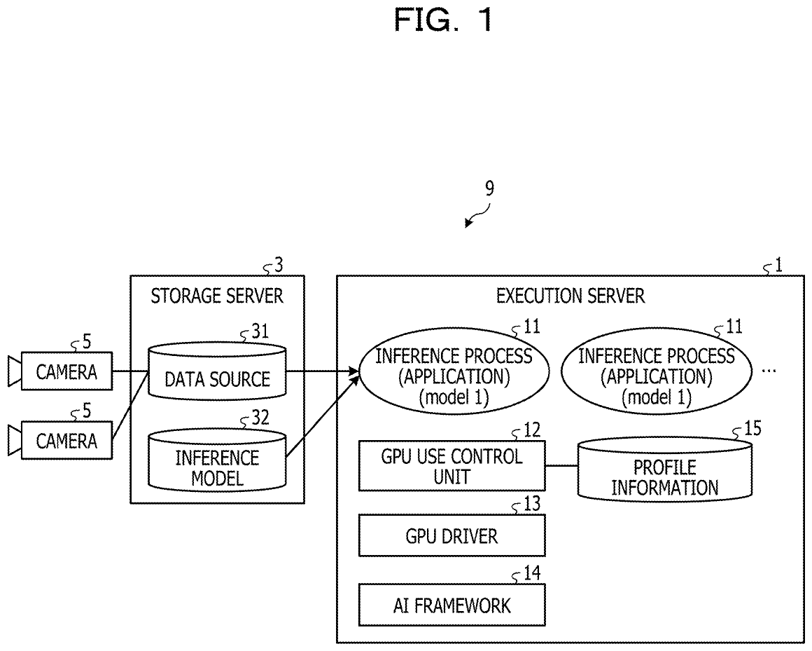

FIG. 1 is a diagram illustrating an example of a functional configuration of a system including an execution server according to the first embodiment. A system 9 includes an execution server 1, a storage server 3, and a plurality of cameras 5. The system 9 executes, in the execution server 1 on which a GPU is mounted, an inference process 11 (application) that performs inference processing on a moving image (video). It is assumed that the system 9 executes a plurality of inference processes 11 with one GPU. For example, the inference process 11 referred to in this case is an application for estimating a suspicious person from a video output from the camera 5 or estimating traffic. The inference process 11 incorporates a predetermined library of an AI framework 14 and executes inference processing by using an inference model 32.

The storage server 3 includes a data source 31 of videos output respectively from the plurality of cameras 5, and the inference model 32. The inference model 32 is a model used for inference processing of the inference process 11 and is based on a predetermined algorithm. In the first embodiment, the inference model 32 based on the same algorithm is used by a plurality of inference processes 11.

In the execution server 1, a GPU use control unit 12 is provided between a plurality of inference processes 11, and a GPU driver 13 and the AI framework 14. The execution server 1 includes profile information 15.

The GPU driver 13 is dedicated software for controlling the GPU. For example, the GPU driver 13 transmits a GPU use request requested from the GPU use control unit 12 to the AI framework 14. The GPU driver 13 transmits the processing result returned from the AI framework 14 to the GPU use control unit 12.

The AI framework 14 executes inference processing of the inference process 11. The AI framework 14 is a library for performing inference processing on a video, and is incorporated in the inference process 11 (application). The AI framework 14 is called by the inference process 11, and executes inference processing via the GPU driver 13. Examples of the AI framework 14 include TensorFlow, MXNet, Pytorch, and the like.

The GPU use control unit 12 monitors a GPU use request from the inference process 11 (application), and changes the start timing of GPU use in the inference process 11. For example, when a plurality of inference processes 11 are executed in an overlapping manner, the GPU use control unit 12 controls the use of the GPU by delaying the start of a subsequent inference process 11 based on a predetermined threshold. In the first embodiment, the predetermined threshold is a value of processing time of a phase, among a plurality of phases included in the inference process 11, having a large influence on processing time when executed in an overlapping manner (with interference). For example, the predetermined threshold is a value of processing time of a phase, among a plurality of phases included in the inference process 11, that increases the processing time when overlapping (interference) occurs. When two inference processes 11 are executed at close timings, the GPU use control unit 12 delays the start of the subsequent inference process 11 by the predetermined threshold from the start of the preceding inference process 11 to suppress an increase in processing time due to interference. In the first embodiment, since the same inference model 32 (algorithm) is used in a plurality of inference processes 11, the processing times of the plurality of phases in each of the plurality of inference processes 11 are the same.

The profile information 15 stores a predetermined threshold. For example, the predetermined threshold is the processing time of convolution processing described later. As an example, the GPU use control unit 12 measures the processing time of convolution processing in advance, and records the processing time in the profile information 15. The profile information 15 is an example of a storage unit.

### Multiple Control According to First Embodiment

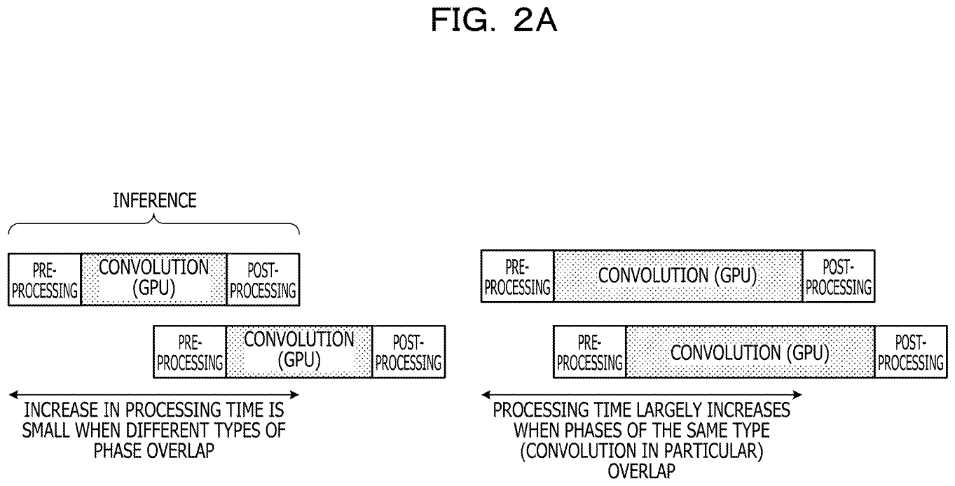

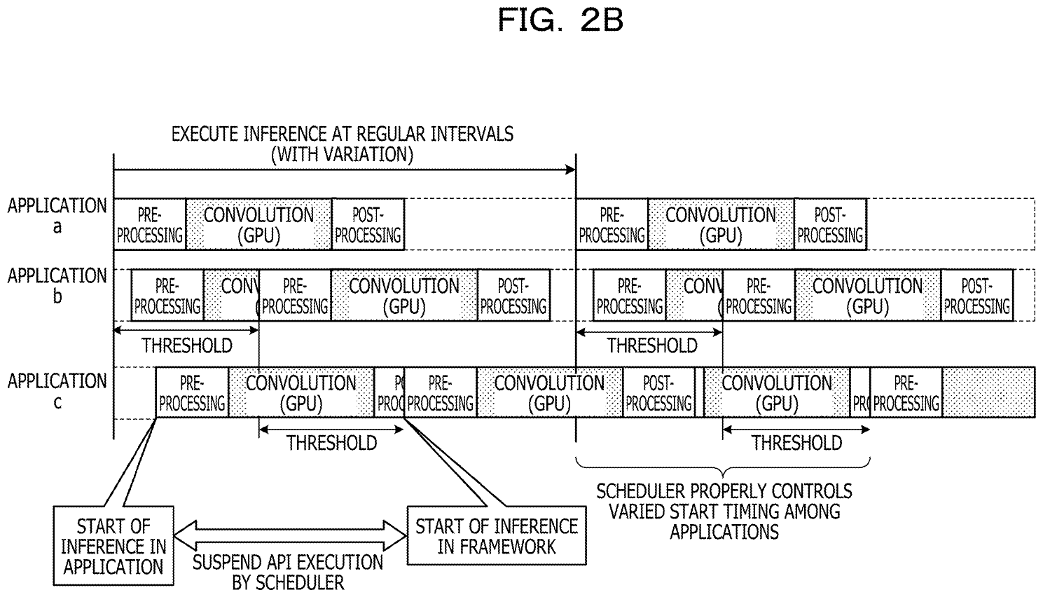

Multiple control according to the first embodiment will be described with reference to FIGS. 2A and 2B. FIGS. 2A and 2B are diagrams for describing multiple control according to the first embodiment. As illustrated in FIG. 2A, the inference process 11 includes three phases. The three phases are preprocessing, convolution processing, and postprocessing, with their characteristics different from each other. For example, preprocessing includes central processing unit (CPU) processing of preparing processed data of the data source 31 and the like and data transfer processing of transferring the data from a CPU to the GPU. For example, convolution processing is data processing using the GPU, which is the core part of deep learning, and is executed by using a convolutional neural network. For example, postprocessing includes data transfer processing of transferring a processing result from the GPU to the CPU and CPU processing of extracting and processing the processing result.

When a plurality of inference processes 11 are executed in an overlapping manner, the influence on an increase in processing time varies depending on the combination of overlapping phases. When phases of the same type overlap, an increase in processing time is large. When different types of phase overlap, an increase in processing time is small. As illustrated in the left diagram of FIG. 2A, when different phases, such as convolution processing and preprocessing, and postprocessing and convolution processing, overlap each other, an increase in processing time is small. On the other hand, as illustrated in the right diagram of FIG. 2A, in particular, when pieces of convolution processing overlap each other, an increase in processing time is large. In the embodiment, the GPU use control unit 12 controls the start timing of the inference process 11 so that the process is not executed with pieces of convolution processing having a large influence on processing time overlapping (interfering with) each other.

For example, when a plurality of inference processes 11 are executed at close timings, the GPU use control unit 12 delays the start of a subsequent inference process 11 by a threshold or more, with the processing time of convolution processing in the inference process 11 as the threshold. The processing time of convolution processing used as the threshold is the processing time of convolution processing measured in a state where the inference process 11 does not overlap another inference process 11, and may be measured in advance.

As illustrated in FIG. 2B, for example, the GPU use control unit 12 causes applications a, b, and c, each indicating the inference process 11, to be executed at close timings. The GPU use control unit 12 transmits a start request (GPU use request) of the application a to the AI framework 14, and causes the AI framework to execute inference processing. The GPU use control unit 12 delays the start of inference processing of the application b subsequent to the application a by a threshold or more from the start of the inference processing of the application a executed immediately before, transmits a start request (GPU use request) of the application b to the AI framework 14, and causes the AI framework to execute inference processing. Thus, the GPU use control unit 12 may perform control such that the convolution processing of the application a and the convolution processing of the application b do not overlap.

The GPU use control unit 12 delays the start of inference processing of the application c subsequent to the application b by the threshold or more from the start of the inference processing of the application b executed immediately before, transmits a start request (GPU use request) of the application c to the AI framework 14, and causes the AI framework to execute inference processing. Thus, the GPU use control unit 12 may perform control such that the convolution processing of the application a, the convolution processing of the application b, and the convolution processing of the application c do not overlap.

[Functional Configuration of GPU Use Control Unit]

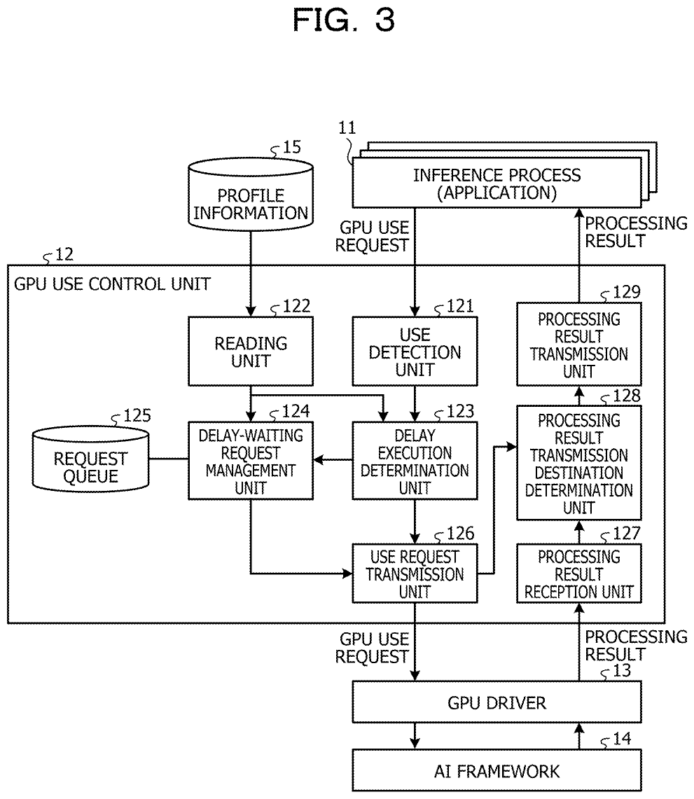

FIG. 3 is a diagram illustrating an example of a functional configuration of a GPU use control unit according to the first embodiment. As illustrated in FIG. 3, the GPU use control unit 12 includes a use detection unit 121, a reading unit 122, a delay execution determination unit 123, a delay-waiting request management unit 124, a request queue 125, a use request transmission unit 126, a processing result reception unit 127, a processing result transmission destination determination unit 128, and a processing result transmission unit 129. The delay execution determination unit 123 and the delay-waiting request management unit 124 are examples of a delay waiting unit.

The use detection unit 121 detects a GPU use request (application start request) from the inference process 11 (application). The GPU use request includes the name of the inference model 32 and the identifier of the data source 31. The use detection unit 121 outputs the process ID of the inference process 11 that has made the detected GPU use request to the delay execution determination unit 123.

The reading unit 122 reads a threshold from the profile information 15. The reading unit 122 outputs the read threshold to the delay execution determination unit 123 described later.

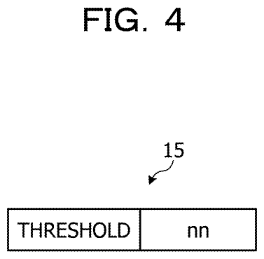

An example of the profile information 15 according to the first embodiment will be described with reference to FIG. 4. FIG. 4 is a diagram illustrating an example of profile information according to the first embodiment. As illustrated in FIG. 4, a threshold is set in the profile information 15. A threshold is a value obtained by measuring the processing time of convolution processing in advance. As an example, “nn” is set as the threshold. “nn” is a positive integer.

Referring back to FIG. 3, the delay execution determination unit 123 determines a delay time caused for executing the inference process 11 for which a GPU use request is made. For example, the delay execution determination unit 123 determines whether the request queue 125 that accumulates GPU use requests is empty. When the request queue 125 is empty, the delay execution determination unit 123 acquires the latest time of GPU use (GPU latest use time). The delay execution determination unit 123 acquires a threshold from the profile information 15. The delay execution determination unit 123 calculates, as a waiting time, a time obtained by subtracting the current time from the time obtained by adding the threshold to the latest use time. When the waiting time is larger than 0, the delay execution determination unit 123 accumulates the GPU use request in the request queue 125, and sets the waiting time in the delay-waiting request management unit 124. For example, the delay execution determination unit 123 performs control to delay the start timing of the (subsequent) inference process 11 for which the GPU use request is made by the threshold or more from the start of use of the preceding inference process 11. For example, the delay execution determination unit 123 performs control so that the convolution processing of the inference process 11 for which the GPU use request is made does not overlap the convolution processing of the preceding inference process 11. When the waiting time is equal to or smaller than 0, the delay execution determination unit 123 makes the GPU use request to the use request transmission unit 126. For example, when the waiting time is equal to or smaller than 0, the GPU latest use time is earlier than the current time by the threshold or more. Thus, the delay execution determination unit 123 determines that the subsequent inference process 11 does not overlap the convolution processing of the preceding inference process 11, and makes a GPU use request for the subsequent inference process 11.

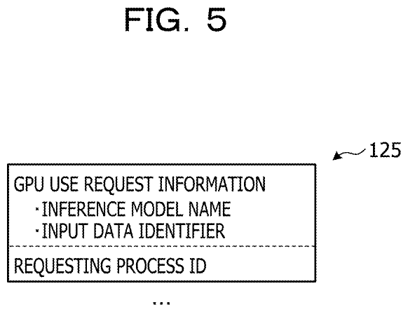

When the request queue 125 is not empty, the delay execution determination unit 123 accumulates the GPU use request in the request queue 125. An example of the data structure of the request queue 125 will be described with reference to FIG. 5.

FIG. 5 is a diagram illustrating an example of the data structure of the request queue. As illustrated in FIG. 5, the request queue 125 holds GPU use request information and a requesting process ID for one GPU use request. The GPU use request information includes an inference model name and an input data identifier. The inference model name is the name of the inference model 32. The input data identifier is an identifier that uniquely identifies the data source 31. The requesting process ID is the process ID of the inference process 11.

Referring back to FIG. 3, the delay-waiting request management unit 124 manages the GPU use requests waiting for delay. For example, the delay-waiting request management unit 124 waits until a waiting time set by the delay execution determination unit 123 passes. After waiting until the waiting time passes, the delay-waiting request management unit 124 makes the first GPU use request in the request queue 125 to the use request transmission unit 126. The delay-waiting request management unit 124 determines whether the request queue 125 is empty. When the request queue 125 is not empty, the delay-waiting request management unit 124 acquires a threshold from the profile information 15, and sets the acquired threshold as the waiting time. For example, the delay-waiting request management unit 124 performs control to delay the start timing of the subsequent inference process 11 by the threshold from the start of use of the currently transmitted inference process 11 so that the convolution processing of the subsequent inference process 11 and the convolution processing of the preceding inference process 11 do not overlap.

The use request transmission unit 126 transmits a GPU use request to the AI framework 14 via the GPU driver 13. For example, the use request transmission unit 126 updates the latest time of GPU use (GPU latest use time) to the current time. The use request transmission unit 126 records the requesting process ID of the GPU use request in association with the GPU latest use time. The association between the GPU latest use time and the requesting process ID is recorded in a storage unit (not illustrated). The use request transmission unit 126 transmits the GPU use request to the GPU driver 13.

The processing result reception unit 127 receives a processing result processed by the AI framework 14 via the GPU driver 13.

The processing result transmission destination determination unit 128 determines a transmission destination of the processing result. For example, the processing result transmission destination determination unit 128 acquires, from the use request transmission unit 126, the requesting process ID associated with the recorded GPU latest use time as the transmission destination of the processing result.

The processing result transmission unit 129 transmits the processing result to the inference process 11 corresponding to the requesting process ID determined by the processing result transmission destination determination unit 128.

[Hardware Configuration of Execution Server]

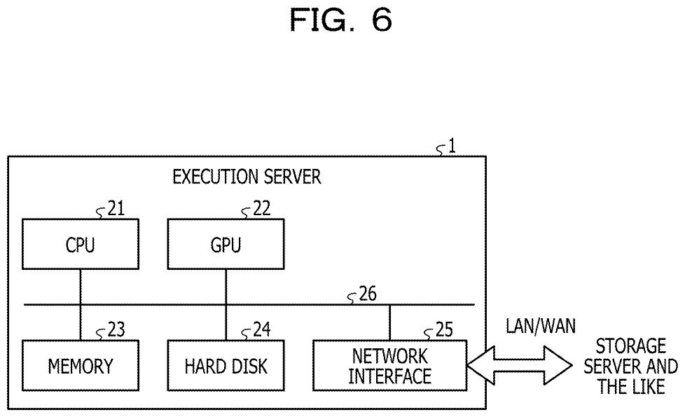

FIG. 6 is a diagram illustrating an example of a hardware configuration of the execution server. As illustrated in FIG. 6, the execution server 1 includes a GPU 22 in addition to a CPU 21. The execution server 1 includes a memory 23, a hard disk 24, and a network interface 25. For example, the components illustrated in FIG. 6 are coupled to each other via a bus 26.

The network interface 25 is a network interface card or the like, and communicates with other devices such as the storage server 3. The hard disk 24 stores the profile information 15 and a program for operating the functions illustrated in FIGS. 1 and 3.

The CPU 21 reads, from the hard disk 24 or the like, a program for executing the same processing as that of each processing unit illustrated in FIGS. 1 and 3 and loads the program into the memory 23, thereby causing a process of executing each function described in FIG. 1, FIG. 3, and the like to operate. For example, this process executes the same function as that of each processing unit of the execution server 1. For example, the CPU 21 reads, from the hard disk 24 or the like, a program including the same functions as those of the inference process 11, the GPU use control unit 12, the GPU driver 13, the AI framework 14, and the like. The CPU 21 executes a process of executing the same pieces of processing as those of the inference process 11, the GPU use control unit 12, the GPU driver 13, the AI framework 14, and the like.

The GPU 22 reads, from the hard disk 24 or the like, a program for executing inference processing of the inference process 11 by using the AI framework 14 illustrated in FIG. 1 and loads the program into the memory 23, thereby causing a process of executing the program to operate. The GPU 22 causes a plurality of inference processes 11 to operate in an overlapping manner.

[Flowchart of GPU Use Control]

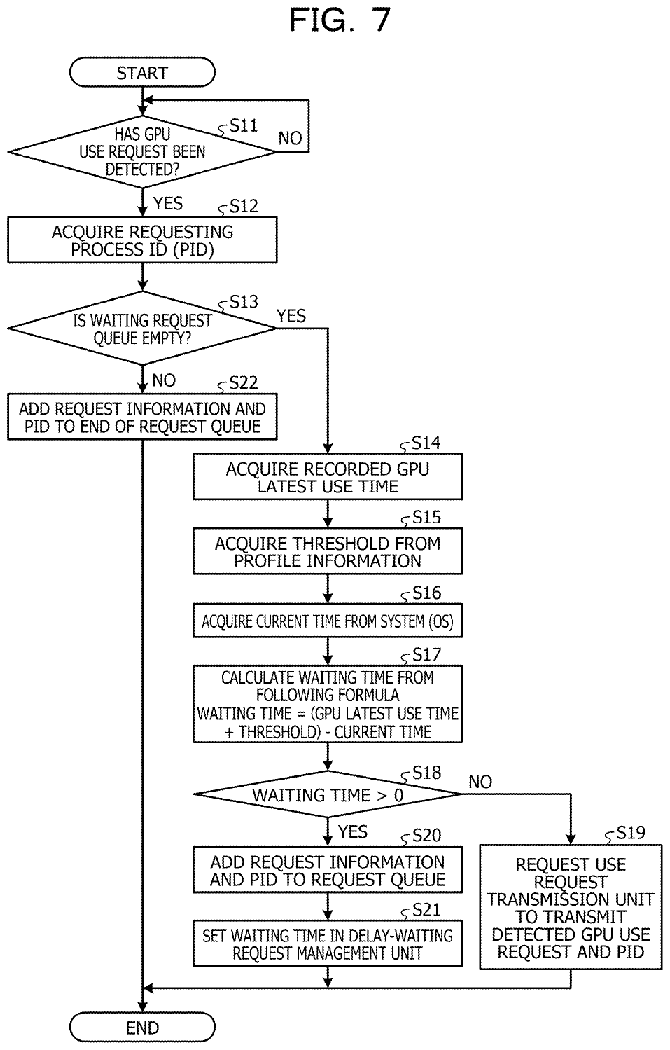

A flowchart of GPU use control processing according to the first embodiment will be described with reference to FIGS. 7 to 10.

[Flowchart of Delay Execution Determination Processing]

FIG. 7 is a diagram illustrating an example of a flowchart of delay execution determination processing according to the first embodiment. As illustrated in FIG. 7, the use detection unit 121 determines whether a GPU use request has been detected (step S11). When it is determined that the GPU use request has not been detected (No in step S11), the use detection unit 121 repeats the determination step until the GPU use request is detected. On the other hand, when it is determined that the GPU use request has been detected (Yes in step S11), the use detection unit 121 acquires the requesting process ID (PID) (step S12).

Next, the delay execution determination unit 123 determines whether the request queue 125 that accumulates waiting use requests is empty (step S13). When it is determined that the request queue 125 is empty (Yes in step S13), the delay execution determination unit 123 acquires the GPU latest use time recorded in the storage unit (not illustrated) (step S14). The GPU latest use time is the latest time of GPU use, and is, for example, a time at which a GPU use request has been most recently transmitted. The GPU latest use time is recorded by the use request transmission unit 126.

The delay execution determination unit 123 acquires a threshold from the profile information 15 (step S15). The delay execution determination unit 123 acquires the current time from a system (operating system (OS)) (step S16). The delay execution determination unit 123 calculates a waiting time from the following formula (1) (step S17).

Waiting time=(GPU latest use time+threshold)−current time (1)

The delay execution determination unit 123 determines whether the waiting time is larger than 0 (step S18). When it is determined that the waiting time is equal to or smaller than 0 (No in step S18), the delay execution determination unit 123 outputs the detected GPU use request and the PID to the use request transmission unit 126, and requests for transmission of the request (step S19). For example, when the waiting time is equal to or smaller than 0, the GPU latest use time is earlier than the current time by the threshold or more. Thus, the delay execution determination unit 123 determines that the subsequent inference process 11 does not overlap the convolution processing of the preceding inference process 11, and makes a GPU use request for the subsequent inference process 11. The delay execution determination unit 123 ends the delay execution determination processing.

On the other hand, when it is determined that the waiting time is larger than 0 (Yes in step S18), the delay execution determination unit 123 adds the GPU use request information and the PID to the request queue 125 (step S20). The delay execution determination unit 123 sets the waiting time in the delay-waiting request management unit 124 (step S21). For example, the delay execution determination unit 123 performs control to delay the start timing of the (subsequent) inference process 11 for which a GPU use request is detected by the threshold or more from the start of use of the preceding inference process 11. For example, the delay execution determination unit 123 performs control so that the convolution processing of the inference process 11 for which the GPU use request is made does not overlap the convolution processing of the preceding inference process 11. The delay execution determination unit 123 ends the delay execution determination processing.

When it is determined in step S13 that the request queue 125 is not empty (No in step S13), the delay execution determination unit 123 adds the GPU use request information and the PID to the end of the request queue 125 (step S22). The delay execution determination unit 123 ends the delay execution determination processing.

[Flowchart of Delay-Waiting Request Management Processing]

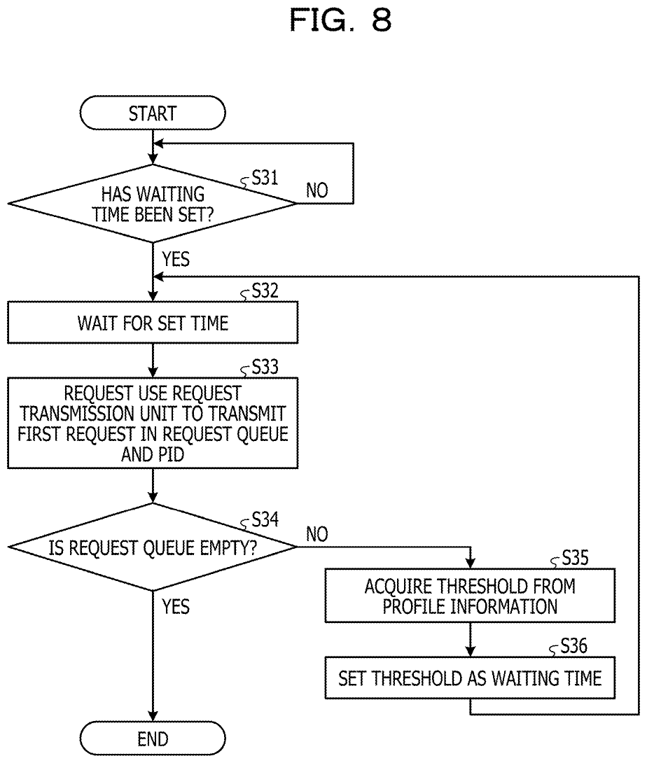

FIG. 8 is a diagram illustrating an example of a flowchart of delay-waiting request management processing according to the first embodiment. As illustrated in FIG. 8, the delay-waiting request management unit 124 determines whether a waiting time has been set (step S31). When it is determined that the waiting time has not been set (No in step S31), the delay-waiting request management unit 124 repeats the determination step until the waiting time is set.

On the other hand, when it is determined that the waiting time has been set (Yes in step S31), the delay-waiting request management unit 124 waits until the set time passes (step S32). After waiting until the set time passes, the delay-waiting request management unit 124 outputs the first request in the request queue 125 and the PID to the use request transmission unit 126, and requests for transmission of the request (step S33).

The delay-waiting request management unit 124 determines whether the request queue 125 is empty (step S34). When it is determined that the request queue 125 is not empty (No in step S34), the delay-waiting request management unit 124 acquires the threshold from the profile information 15 (step S35). The delay-waiting request management unit 124 sets the threshold as a waiting time in order for the next request to wait (step S36). For example, the delay-waiting request management unit 124 performs control to delay the start timing of the inference process 11 for which the next GPU use request is made by the threshold or more from the start of the use of the preceding inference process 11. The delay-waiting request management unit 124 proceeds to step S32.

On the other hand, when it is determined that the request queue 125 is empty (Yes in step S34), the delay-waiting request management unit 124 ends the delay-waiting request management processing.

[Flowchart of Use Request Transmission Processing]

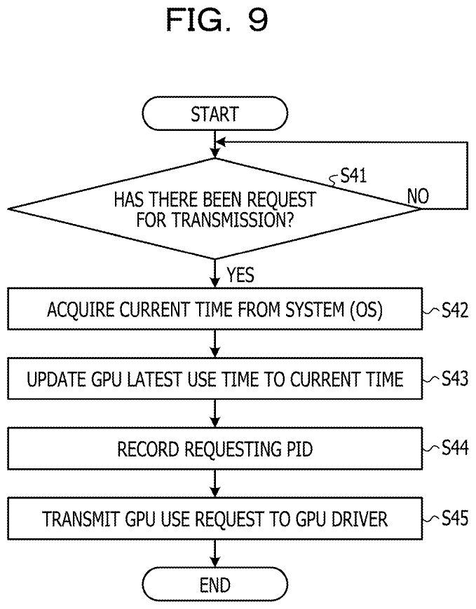

FIG. 9 is a diagram illustrating an example of a flowchart of use request transmission processing according to the first embodiment. As illustrated in FIG. 9, the use request transmission unit 126 determines whether there has been a request for transmission of a GPU use request (step S41). When it is determined that there has been no request for transmission of a GPU use request (No in step S41), the use request transmission unit 126 repeats the determination step until there is a transmission request.

On the other hand, when it is determined that there has been a request for transmission of a GPU use request (Yes in step S41), the use request transmission unit 126 acquires the current time from the system (OS) (step S42). The use request transmission unit 126 updates the GPU latest use time to the current time (step S43). The use request transmission unit 126 records the requesting PID in association with the GPU latest use time (step S44).

The use request transmission unit 126 transmits the GPU use request to the GPU driver 13 (step S45). The use request transmission unit 126 ends the use request transmission processing.

[Flowchart of Processing Result Transmission Destination Determination Processing]

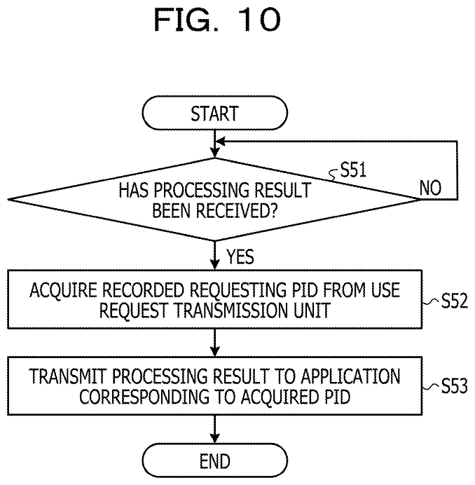

FIG. 10 is a diagram illustrating an example of a flowchart of processing result transmission destination determination processing according to the first embodiment. As illustrated in FIG. 10, the processing result transmission destination determination unit 128 determines whether a processing result has been received (step S51). When it is determined that the processing result has not been received (No in step S51), the processing result transmission destination determination unit 128 repeats the determination step until the processing result is received.

On the other hand, when it is determined that the processing result has been received (Yes in step S51), the processing result transmission destination determination unit 128 acquires the recorded requesting PID from the use request transmission unit 126 (step S52). The processing result transmission destination determination unit 128 transmits the processing result to the application (the inference process 11) corresponding to the acquired PID (step S53). The processing result transmission destination determination unit 128 ends the processing result transmission destination determination processing.

### Effects of First Embodiment

As described above, in the first embodiment, when processes of a plurality of applications are executed in an overlapping manner, the execution server 1 records, in the profile information 15, the processing time of the first step in the processes of the plurality of application as a threshold. When receiving an execution request from a subsequent application during execution of a process of any application among the plurality of applications, the execution server 1 delays the start of the process of the subsequent application by a threshold or more from the start of the process of the preceding application being executed. With such a configuration, the execution server 1 may perform control such that the first steps do not overlap, and may suppress an increase in processing time due to overlapping execution of the first steps.

In the first embodiment, the execution server 1 delays the start of the process of the subsequent application by a value obtained by subtracting the time of the timing of the execution request of the subsequent application from the value obtained by adding the threshold to the start time of the preceding application being executed, or more. With such a configuration, the execution server 1 may delay the start of the process of the subsequent application by such a length of time that the first steps do not overlap, or longer.

In the first embodiment, when processes of a plurality of applications use the same algorithm, the execution server 1 sets a value obtained by measuring the processing time of the first step as the threshold. With such a configuration, by using the value obtained by measuring the processing time of the first step as the threshold, the execution server 1 may suppress an increase in processing time due to overlapping execution of the first steps.

### Second Embodiment

In the first embodiment, when a plurality of inference processes 11 are executed in an overlapping manner, the same inference model 32 (algorithm) is used in the inference processes 11. For example, the execution server 1 measures the processing time of the convolution processing of any inference process 11 and records the processing time as a threshold in the profile information 15, and delays the start timing of a subsequent inference process 11 by the threshold or more from the start of use of a preceding inference process 11. However, without being limited to the case of the first embodiment, different inference models 32 (algorithms) may be used in a plurality of inference processes 11 when the inference processes 11 are executed in an overlapping manner.

In the second embodiment, a case will be described in which different inference models 32 (algorithms) are used in a plurality of inference processes 11 when the inference processes 11 are executed in an overlapping manner.

[Functional Configuration of GPU Use Control Unit]

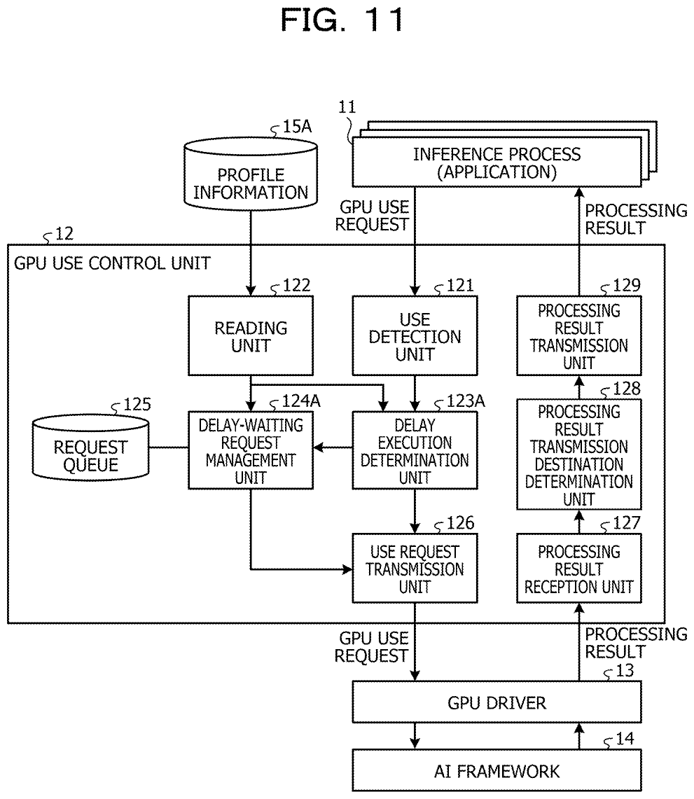

FIG. 11 is a diagram illustrating an example of a functional configuration of a GPU use control unit according to the second embodiment. Elements of the GPU use control unit of FIG. 11 are designated with the same reference numerals as in the GPU use control unit illustrated in FIG. 3, and the description of the identical elements and operation thereof is omitted herein. The second embodiment is different from the first embodiment in that the profile information 15 is changed to profile information 15A. The second embodiment is different from the first embodiment in that the delay execution determination unit 123 and the delay-waiting request management unit 124 are changed to a delay execution determination unit 123A and a delay-waiting request management unit 124A, respectively.

The profile information 15A stores the processing time of preprocessing and the processing time of convolution processing for each inference model 32 (algorithm). As an example, the GPU use control unit 12 measures the processing time of preprocessing and the processing time of convolution processing for each inference model 32 in advance, and records them in the profile information 15A.

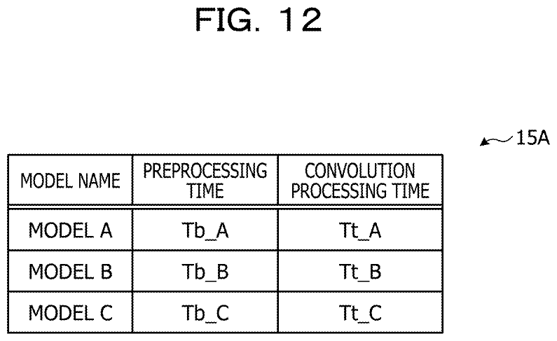

An example of the profile information 15A according to the second embodiment will be described with reference to FIG. 12. FIG. 12 is a diagram illustrating an example of profile information according to the second embodiment. As illustrated in FIG. 12, the profile information 15A stores model name, preprocessing time, and convolution processing time in association with each other. Model name is the name of the inference model 32 used for the inference processing of the inference process 11. Preprocessing time is the processing time of the preprocessing of the inference process 11 in which the inference model 32 indicated by the model name is used. Convolution processing time is the processing time of the convolution processing of the inference process 11 in which the inference model 32 indicated by the model name is used. The preprocessing time and the convolution processing time for each model name are values obtained by measurement in advance.

As an example, when model name is “model A”, “Tb_A” is stored as the preprocessing time and “Tt_A” is stored as the convolution processing time. When model name is “model B”, “Tb_B” is stored as the preprocessing time and “Tt_B” is stored as the convolution processing time. When model name is “model C”, “Tb_C” is stored as the preprocessing time and “Tt_C” is stored as the convolution processing time. “Tb_A”, “Tt_A”, “Tb_B”, “Tt_B”, “Tb_C”, and “Tt_C” are positive integers.

Referring back to FIG. 11, the delay execution determination unit 123A determines a delay time caused for executing the inference process 11 for which a GPU use request is made.

For example, the delay execution determination unit 123A acquires the model name of the inference model 32 included in the GPU use request. The delay execution determination unit 123A determines whether the request queue 125 that accumulates GPU use requests is empty. When the request queue 125 is empty, the delay execution determination unit 123A acquires the latest time of GPU use (GPU latest use time) and the model name of the latest used inference model 32. For example, the delay execution determination unit 123A acquires the model name of the inference model 32 used in the inference process 11 executed immediately before (preceding inference process). The delay execution determination unit 123A acquires, from the profile information 15A, the preprocessing time and the convolution processing time corresponding to the model name of the inference model 32 used in the preceding inference process 11. The delay execution determination unit 123A acquires, from the profile information 15A, the preprocessing time and the convolution processing time corresponding to the model name of the inference model 32 used in the requesting (subsequent) inference process 11.

The delay execution determination unit 123A calculates, as a threshold, a value obtained by subtracting the preprocessing time corresponding to the inference model 32 used in the subsequent inference process 11 from the value obtained by adding the preprocessing time and the convolution processing time corresponding to the inference model 32 used in the preceding inference process 11. For example, the delay execution determination unit 123A calculates the threshold based on the combination of the inference model 32 used in the preceding inference process 11 and the inference model 32 used in the subsequent inference process 11.

The delay execution determination unit 123A calculates, as a waiting time, a time obtained by subtracting the current time from the time obtained by adding the threshold to the latest use time. When the waiting time is larger than 0, the delay execution determination unit 123A accumulates the GPU use request in the request queue 125, and sets the waiting time in the delay-waiting request management unit 124A. For example, the delay execution determination unit 123A performs control to delay the start timing of the (subsequent) inference process 11 for which the GPU use request is made by the threshold or more from the start of use of the preceding inference process 11. For example, the delay execution determination unit 123A performs control such that the convolution processing of the inference process 11 for which the GPU use request is made does not overlap the convolution processing of the preceding inference process 11. When the waiting time is equal to or smaller than 0, the delay execution determination unit 123A makes the GPU use request to the use request transmission unit 126. For example, when the waiting time is equal to or smaller than 0, the GPU latest use time is earlier than the current time by the threshold or more. Thus, the delay execution determination unit 123A determines that the subsequent inference process 11 does not overlap the convolution processing of the preceding inference process 11, and makes a GPU use request for the subsequent inference process 11.

The delay-waiting request management unit 124A manages the GPU use requests waiting for delay. For example, the delay-waiting request management unit 124A waits until a waiting time set by the delay execution determination unit 123A passes. After waiting until the waiting time passes, the delay-waiting request management unit 124A makes the first GPU use request in the request queue 125 to the use request transmission unit 126. The delay-waiting request management unit 124A determines whether the request queue 125 is empty. When the request queue 125 is not empty, the delay-waiting request management unit 124A acquires the inference model name of the first request in the request queue 125. The delay-waiting request management unit 124A acquires the model name of the inference model 32 used in the inference process 11 executed immediately before (preceding inference process). The delay-waiting request management unit 124A acquires, from the profile information 15A, the preprocessing time and the convolution processing time corresponding to the inference model name of the request. The delay-waiting request management unit 124A acquires, from the profile information 15A, the preprocessing time and the convolution processing time corresponding to the model name of the inference model 32 used in the preceding inference process 11.

The delay-waiting request management unit 124A calculates, as a threshold, a value obtained by subtracting the preprocessing time corresponding to the inference model name of the request from the value obtained by adding the preprocessing time and the convolution processing time corresponding to the inference model 32 used in the preceding inference process 11. For example, the delay-waiting request management unit 124A calculates the threshold based on the combination of the inference model 32 used in the preceding inference process 11 and the inference model 32 used in the inference process 11 for which the request is made.

The delay-waiting request management unit 124A sets the calculated threshold value as the waiting time. For example, the delay-waiting request management unit 124A performs control to delay the start timing of the subsequent inference process 11 by the threshold from the start of use of the currently transmitted inference process 11 so that the convolution processing of the subsequent inference process 11 and the convolution processing of the preceding inference process 11 do not overlap.

[Flowchart of GPU Use Control]

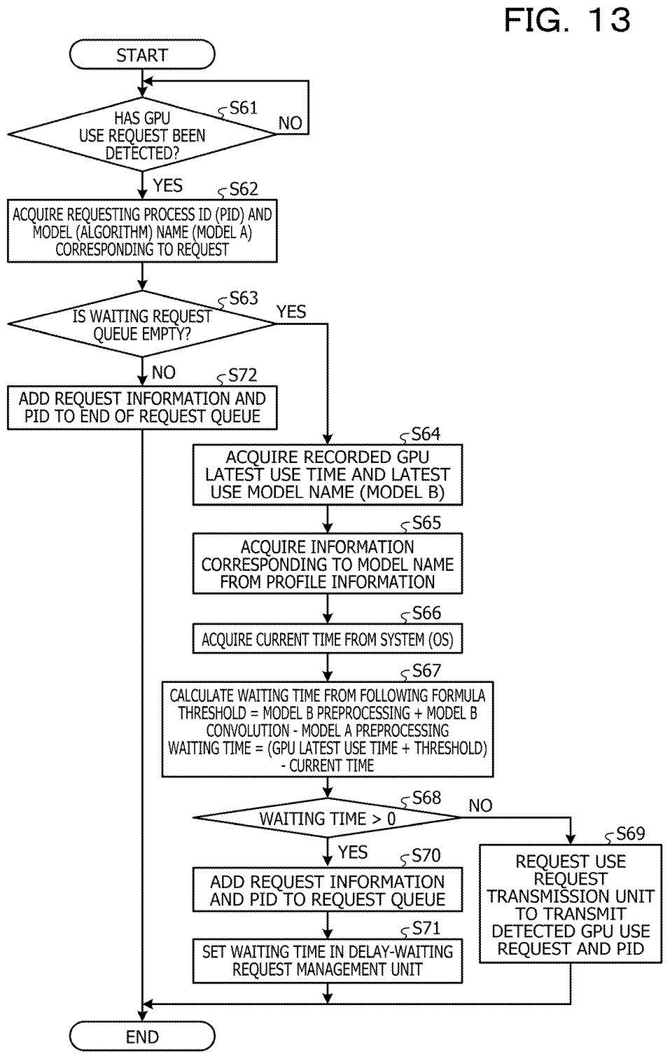

A flowchart of delay execution determination processing according to the second embodiment will be described with reference to FIG. 13. FIG. 13 is a diagram illustrating an example of a flowchart of delay execution determination processing according to the second embodiment. As illustrated in FIG. 13, the use detection unit 121 determines whether a GPU use request has been detected (step S61). When it is determined that the GPU use request has not been detected (No in step S61), the use detection unit 121 repeats the determination step until the GPU use request is detected. On the other hand, when it is determined that the GPU use request has been detected (Yes in step S61), the use detection unit 121 acquires the requesting process ID (PID) and the model name corresponding to the request (step S62). In this case, the model name corresponding to the request is “model A”.

Next, the delay execution determination unit 123A determines whether the request queue 125 that accumulates waiting use requests is empty (step S63). When it is determined that the request queue 125 is empty (Yes in step S63), the delay execution determination unit 123A acquires the recorded GPU latest use time and latest use model name (step S64). In this case, the latest use model name is “model B”. The GPU latest use time and the latest use model name are recorded by the use request transmission unit 126.

The delay execution determination unit 123A acquires information corresponding to the model name from the profile information 15A (step S65). In this case, the delay execution determination unit 123A acquires, from the profile information 15A, the preprocessing time and the convolution processing time corresponding to the latest use model name (model B). The delay execution determination unit 123A acquires, from the profile information 15A, the preprocessing time and the convolution processing time corresponding to the model name corresponding to the request (model A).

The delay execution determination unit 123A acquires the current time from the system (OS) (step S66). The delay execution determination unit 123 calculates a threshold from the following formula (2), and calculates a waiting time from formula (3) by using the calculated threshold (step S67). Formula (3) is the same as formula (1).

Threshold=model B preprocessing time+model B convolution processing time−model A preprocessing time (2)

Waiting time=(GPU latest use time+threshold)−current time (3)

The delay execution determination unit 123A determines whether the waiting time is larger than 0 (step S68). When it is determined that the waiting time is equal to or smaller than 0 (No in step S68), the delay execution determination unit 123A outputs the detected GPU use request and the PID to the use request transmission unit 126, and requests for transmission of the request (step S69). For example, when the waiting time is equal to or smaller than 0, the GPU latest use time is earlier than the current time by the threshold or more. Thus, the delay execution determination unit 123A determines that the subsequent inference process 11 does not overlap the convolution processing of the preceding inference process 11, and makes a GPU use request for the subsequent inference process 11. The delay execution determination unit 123A ends the delay execution determination processing.

On the other hand, when it is determined that the waiting time is larger than 0 (Yes in step S68), the delay execution determination unit 123A adds the GPU use request information and the PID to the request queue 125 (step S70). The delay execution determination unit 123A sets the waiting time in the delay-waiting request management unit 124A (step S71). For example, the delay execution determination unit 123A performs control to delay the start timing of the subsequent inference process 11 by the threshold or more from the start of use of the preceding inference process 11 so that the subsequent inference process 11 does not overlap the convolution processing of the preceding inference process 11 that largely affects the processing time. The delay execution determination unit 123A ends the delay execution determination processing.

When it is determined in step S63 that the request queue 125 is not empty (No in step S63), the delay execution determination unit 123A adds the GPU use request information and the PID to the end of the request queue 125 (step S72). The delay execution determination unit 123A ends the delay execution determination processing.

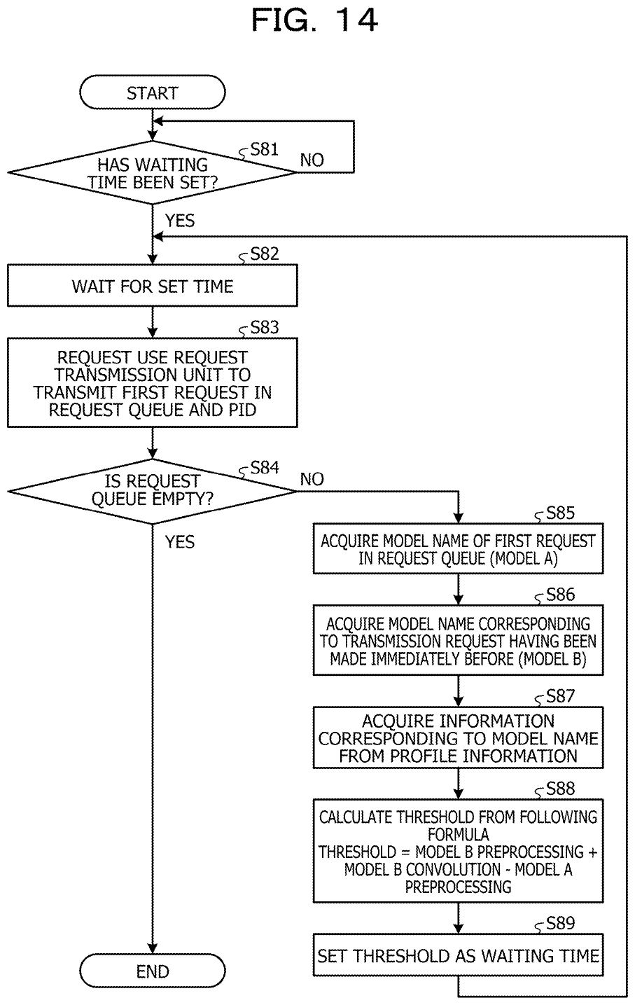

FIG. 14 is a diagram illustrating an example of a flowchart of delay-waiting request management processing according to the second embodiment. As illustrated in FIG. 14, the delay-waiting request management unit 124A determines whether a waiting time has been set (step S81). When it is determined that the waiting time has not been set (No in step S81), the delay-waiting request management unit 124A repeats the determination step until the waiting time is set.

On the other hand, when it is determined that the waiting time has been set (Yes in step S81), the delay-waiting request management unit 124A waits until the set time passes (step S82). After waiting until the set time passes, the delay-waiting request management unit 124A outputs the first request in the request queue 125 and the PID to the use request transmission unit 126, and requests for transmission of the request (step S83).

The delay-waiting request management unit 124A determines whether the request queue 125 is empty (step S84). When it is determined that the request queue 125 is not empty (No in step S84), the delay-waiting request management unit 124A acquires the model name of the first request in the request queue 125 (step S85). In this case, the model name of the first request is model A. The delay-waiting request management unit 124A acquires the model name corresponding to the transmission request having been made immediately before (step S86). In this case, the model name corresponding to the transmission request having been made immediately before is model B. The delay-waiting request management unit 124A may acquire the model name associated with the GPU latest use time as the model name corresponding to the transmission request having been made immediately before.

The delay-waiting request management unit 124A acquires information corresponding to the model name from the profile information 15A (step S87). In this case, the delay-waiting request management unit 124A acquires the preprocessing time and the convolution processing time corresponding to model A, and acquires the preprocessing time and the convolution processing time corresponding to model B, from the profile information 15A.

The delay-waiting request management unit 124A calculates a threshold from the above-described formula (2) (step S88). The delay-waiting request management unit 124A sets the threshold as a waiting time in order for the next request to wait (step S89). The delay-waiting request management unit 124A proceeds to step S82.

On the other hand, when it is determined that the request queue 125 is empty (Yes in step S84), the delay-waiting request management unit 124A ends the delay-waiting request management processing.

### Effects of Second Embodiment

As described above, in the second embodiment, when processes of a plurality of applications use different algorithms, the execution server 1 records, for each algorithm, the processing time of the first step and the processing time of the second step before the first step in the profile information 15A. The execution server 1 calculates a threshold from the processing time of the first step and the processing time of the second step corresponding to the algorithm in the process of the preceding application being executed, and the processing time of the first step corresponding to the algorithm in the process of the subsequent application. The execution server 1 delays the start of the process of the subsequent application by the threshold or more from the start of the process of the preceding application being executed. With such a configuration, even when processes of a plurality of applications use different algorithms, the execution server 1 may suppress an increase in processing time due to overlapping execution of the first steps.

### Third Embodiment

In the first embodiment, the execution server 1 measures the processing time of the convolution processing of any inference process 11 and records the processing time in the profile information 15 as a threshold in advance, and reads and uses the threshold to perform control of delaying the start timing of the subsequent inference process 11. However, the GPU that measures a threshold in advance may be different from the GPU that actually executes GPU use control processing.

In the third embodiment, description will be given for GPU use control processing executed when the GPU that measures a threshold in advance is different from the GPU that actually executes the GPU use control processing.

[Functional Configuration of GPU Use Control Unit]

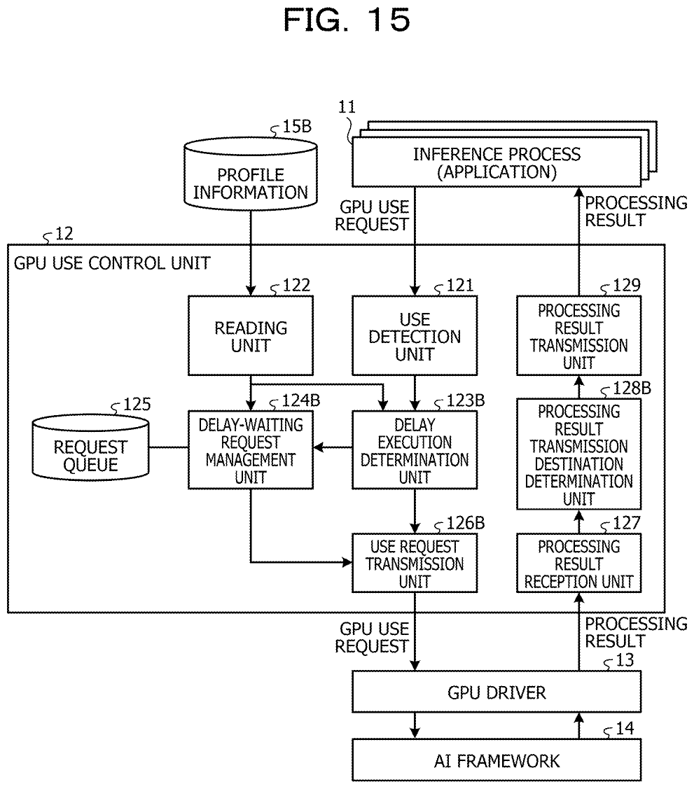

FIG. 15 is a diagram illustrating an example of a functional configuration of a GPU use control unit according to the third embodiment. Elements of the GPU use control unit of FIG. 11 are designated with the same reference numerals as in the GPU use control unit illustrated in FIG. 3, and the description of the identical elements and operation thereof is omitted herein. The third embodiment is different from the first embodiment in that the profile information 15 is changed to profile information 15B. The third embodiment is different from the first embodiment in that the delay execution determination unit 123, the delay-waiting request management unit 124, the use request transmission unit 126, and the processing result transmission destination determination unit 128 are changed to a delay execution determination unit 123B, a delay-waiting request management unit 124B, a use request transmission unit 126B, and a processing result transmission destination determination unit 128B, respectively.

The profile information 15B stores processing time in addition to a predetermined threshold. The profile information 15B also stores a coefficient for each inference process 11. A threshold is a value obtained by measuring the processing time of convolution processing in advance using a first GPU. Processing time is the entire execution time taken when the inference process 11 is executed by using the first GPU in advance. A coefficient is a ratio between the entire execution time measured in advance using the first GPU and actual processing time taken when the processing is actually executed using a second GPU. Actual processing time and coefficient are calculated by the processing result transmission destination determination unit 128B.

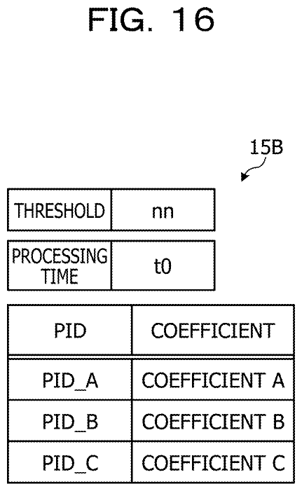

An example of the profile information 15B according to the third embodiment will be described with reference to FIG. 16. FIG. 16 is a diagram illustrating an example of profile information according to the third embodiment. As illustrated in FIG. 16, processing time is set in the profile information 15B in addition to threshold. PID and coefficient are set in the profile information 15B in association with each other. PID is a process ID of the inference process 11 that has been executed.

As an example, “nn” is stored as the threshold. “t0” is stored as the processing time. “nn” and “t0” are positive integers. When PID is “PID_A”, “coefficient A” is stored as the coefficient.

Referring back to FIG. 15, the delay execution determination unit 123B determines a delay time caused for executing the inference process 11 for which a GPU use request is made. For example, the delay execution determination unit 123B determines whether the request queue 125 that accumulates GPU use requests is empty. When the request queue 125 is empty, the delay execution determination unit 123B acquires the latest time of GPU use (GPU latest use time). The delay execution determination unit 123B acquires, from the profile information 15B, the threshold and the coefficient corresponding to the process ID of the inference process 11. The delay execution determination unit 123B calculates a new threshold obtained by multiplying the threshold by the coefficient. The delay execution determination unit 123B calculates, as a waiting time, a time obtained by subtracting the current time from the time obtained by adding the new threshold to the latest use time. When the waiting time is larger than 0, the delay execution determination unit 123B accumulates the GPU use request in the request queue 125, and sets the waiting time in the delay-waiting request management unit 124B. When the waiting time is equal to or smaller than 0, the delay execution determination unit 123B makes the GPU use request to the use request transmission unit 126B.

When the request queue 125 is not empty, the delay execution determination unit 123B accumulates the GPU use request in the request queue 125.

When the coefficient corresponding to the process ID is not set in the profile information 15B, the delay execution determination unit 123B requests the use request transmission unit 126B to execute the GPU use request if the GPU is available. This is to cause the processing result transmission destination determination unit 128B to calculate the actual processing time by causing the target use request to be executed at a timing when no load is applied to the GPU, and to calculate the coefficient corresponding to the process ID of the inference process 11 that has issued the target use request.

The delay-waiting request management unit 124B manages the GPU use requests waiting for delay. For example, the delay-waiting request management unit 124B waits until a waiting time set by the delay execution determination unit 123B passes. After waiting until the waiting time passes, the delay-waiting request management unit 124B makes the first GPU use request in the request queue 125 to the use request transmission unit 126B. The delay-waiting request management unit 124B determines whether the request queue 125 is empty. When the request queue 125 is not empty, the delay-waiting request management unit 124B acquires, from the profile information 15B, the threshold and the coefficient corresponding to the first process ID accumulated in the request queue 125. The delay-waiting request management unit 124B sets, as a waiting time, a new threshold obtained by multiplying the threshold by the coefficient.

When the coefficient corresponding to the process ID is not set in the profile information 15B, the delay-waiting request management unit 124B requests the use request transmission unit 126B to execute the GPU use request if the GPU is available. This is to cause the processing result transmission destination determination unit 128B to calculate the actual processing time by causing the target use request to be executed at a timing when no load is applied to the GPU, and to calculate the coefficient corresponding to the process ID of the inference process 11 that has issued the target use request.

The use request transmission unit 126B transmits a GPU use request to the AI framework 14 via the GPU driver 13. For example, the use request transmission unit 126B updates the latest time of GPU use (GPU latest use time) to the current time. The use request transmission unit 126B records the requesting process ID of the GPU use request in association with the GPU latest use time. The use request transmission unit 126B transmits the GPU use request to the GPU driver 13. The use request transmission unit 126B records the processing state of GPU as “processing”.

The processing result transmission destination determination unit 128B determines a transmission destination of the processing result.

For example, the processing result transmission destination determination unit 128B records the processing state of GPU as “available” indicating that the GPU is not processing. The processing result transmission destination determination unit 128B acquires, as the transmission destination of the processing result, the recorded requesting process ID associated with the GPU latest use time from the use request transmission unit 126B. The processing result transmission destination determination unit 128B transmits the processing result to the inference process 11 corresponding to the requesting process ID via the processing result transmission unit 129.

When the coefficient corresponding to the process ID is not set in the profile information 15B, the processing result transmission destination determination unit 128B calculates the coefficient corresponding to the process ID. As an example, the processing result transmission destination determination unit 128B calculates an actual processing time obtained by subtracting the latest use time from the current time. The use request transmission unit 126B calculates a value obtained by dividing the actual processing time by the processing time set in the profile information 15B as a coefficient, and records the value in the profile information 15B.

[Flowchart of Delay Execution Determination Processing]

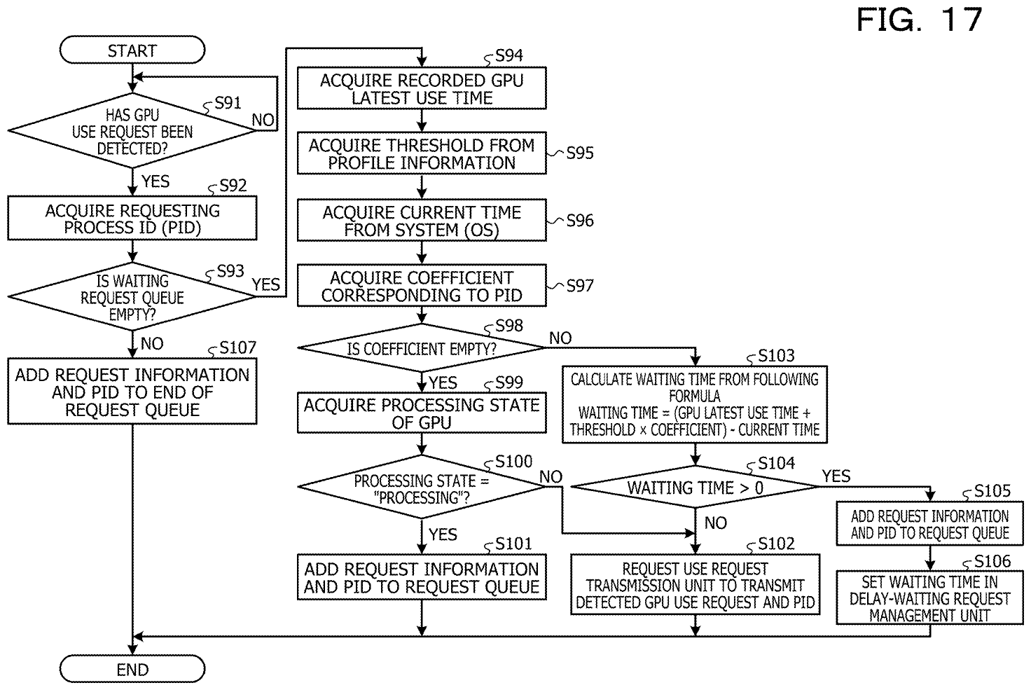

FIG. 17 is a diagram illustrating an example of a flowchart of delay execution determination processing according to the third embodiment. As illustrated in FIG. 17, the use detection unit 121 determines whether a GPU use request has been detected (step S91). When it is determined that the GPU use request has not been detected (No in step S91), the use detection unit 121 repeats the determination step until the GPU use request is detected. On the other hand, when it is determined that the GPU use request has been detected (Yes in step S91), the use detection unit 121 acquires the requesting process ID (PID) (step S92).

Next, the delay execution determination unit 123B determines whether the request queue 125 that accumulates waiting use requests is empty (step S93). When it is determined that the request queue 125 is empty (Yes in step S93), the delay execution determination unit 123B acquires the recorded GPU latest use time (step S94). The GPU latest use time is the latest time of GPU use, and is, for example, a time at which a GPU use request has been most recently transmitted. The GPU latest use time is recorded by the use request transmission unit 126B.

The delay execution determination unit 123B acquires a threshold from the profile information 15B (step S95). The delay execution determination unit 123B acquires the current time from the system (OS) (step S96). The delay execution determination unit 123B acquires the coefficient corresponding to the PID from the profile information 15B (step S97).

The delay execution determination unit 123B determines whether coefficient is empty (step S98). When it is determined that coefficient is empty (Yes in step S98), the delay execution determination unit 123B acquires the processing state of GPU (step S99). The delay execution determination unit 123B determines whether the processing state is “processing” (step S100). When it is determined that the processing state is not “processing” (No in step S100), the delay execution determination unit 123B proceeds to step S102 to request for transmission of the GPU use request. This is to cause the processing result transmission destination determination unit 128B to calculate the actual processing time by causing the target use request to be executed at a timing when no load is applied to the GPU, and to calculate the coefficient corresponding to the process ID of the inference process 11 that has issued the target use request.

On the other hand, when it is determined that the processing state is “processing” (Yes in step S100), the delay execution determination unit 123B adds the GPU use request information and the requesting process ID to the request queue 125 (step S101). In such a case, since a coefficient is not set, the delay execution determination unit 123B may not calculate a waiting time and does not set the waiting time in the delay-waiting request management unit 124B. The delay execution determination unit 123B ends the delay execution determination processing.

When it is determined in step S98 that coefficient is not empty (No in step S98), the delay execution determination unit 123B calculates a waiting time from the following formula (4) (step S103).

Waiting time=(GPU latest use time+threshold×coefficient)−current time (4)

The delay execution determination unit 123B determines whether the waiting time is larger than 0 (step S104). When it is determined that the waiting time is equal to or smaller than 0 (No in step S104), the delay execution determination unit 123B outputs the detected GPU use request and the PID to the use request transmission unit 126B, and requests for transmission of the request (step S102). The delay execution determination unit 123B ends the delay execution determination processing.

On the other hand, when it is determined that the waiting time is larger than 0 (Yes in step S104), the delay execution determination unit 123B adds the GPU use request information and the PID to the request queue 125 (step S105). The delay execution determination unit 123B sets the waiting time in the delay-waiting request management unit 124B (step S106). The delay execution determination unit 123B ends the delay execution determination processing.

When it is determined in step S93 that the request queue 125 is not empty (No in step S93), the delay execution determination unit 123B adds the GPU use request information and the PID to the end of the request queue 125 (step S107). The delay execution determination unit 123B ends the delay execution determination processing.

[Flowchart of Delay-Waiting Request Management Processing]

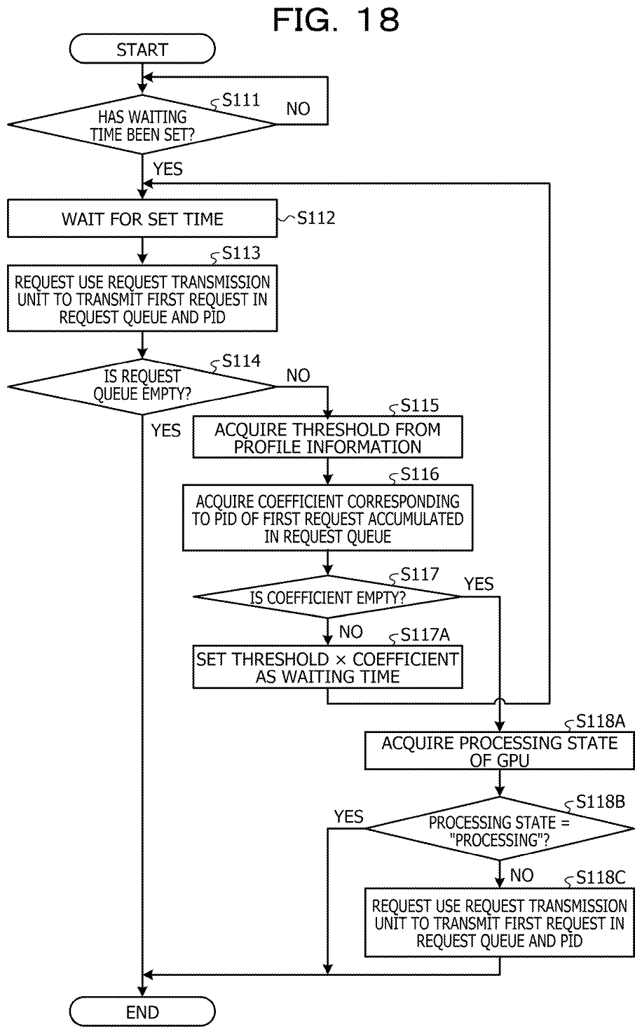

FIG. 18 is a diagram illustrating an example of a flowchart of delay-waiting request management processing according to the third embodiment. As illustrated in FIG. 18, the delay-waiting request management unit 124B determines whether a waiting time has been set (step S111). When it is determined that the waiting time has not been set (No in step S111), the delay-waiting request management unit 124B repeats the determination step until the waiting time is set.

On the other hand, when it is determined that the waiting time has been set (Yes in step S111), the delay-waiting request management unit 124B waits until the set time passes (step S112). After waiting until the set time passes, the delay-waiting request management unit 124B outputs the first request in the request queue 125 and the PID to the use request transmission unit 126B, and requests for transmission of the request (step S113).

The delay-waiting request management unit 124B determines whether the request queue 125 is empty (step S114). When it is determined that the request queue 125 is not empty (No in step S114), the delay-waiting request management unit 124B acquires the threshold from the profile information 15B (step S115). The delay-waiting request management unit 124B acquires the coefficient corresponding to the PID of the first request in the request queue 125 (step S116).

The delay-waiting request management unit 124B determines whether coefficient is empty (step S117). When it is determined that coefficient is not empty (No in step S117), the delay-waiting request management unit 124B sets, as a waiting time, a value obtained by multiplying the threshold by the coefficient in order for the next request to wait (step S117A). The delay-waiting request management unit 124B proceeds to step S112.

On the other hand, when it is determined that coefficient is empty (Yes in step S117), the delay-waiting request management unit 124B acquires the processing state of GPU (step S118A). The delay-waiting request management unit 124B determines whether the processing state is “processing” (step S118B). When it is determined that the processing state is “processing” (Yes in step S118B), the delay-waiting request management unit 124B ends the delay-waiting request management processing.

On the other hand, when it is determined that the processing state is not “processing” (No in step S118B), the delay-waiting request management unit 124B outputs the first request in the request queue 125 and the PID to the use request transmission unit 126B, and requests for transmission of the request (step S118C). This is to cause the processing result transmission destination determination unit 128B to calculate the actual processing time by causing the target use request to be executed at a timing when no load is applied to the GPU, and to calculate the coefficient corresponding to the process ID of the inference process 11 that has issued the target use request. The delay-waiting request management unit 124B ends the delay-waiting request management processing.

When it is determined in step S114 that the request queue 125 is empty (Yes in step S114), the delay-waiting request management unit 124B ends the delay-waiting request management processing.

[Flowchart of Use Request Transmission Processing]

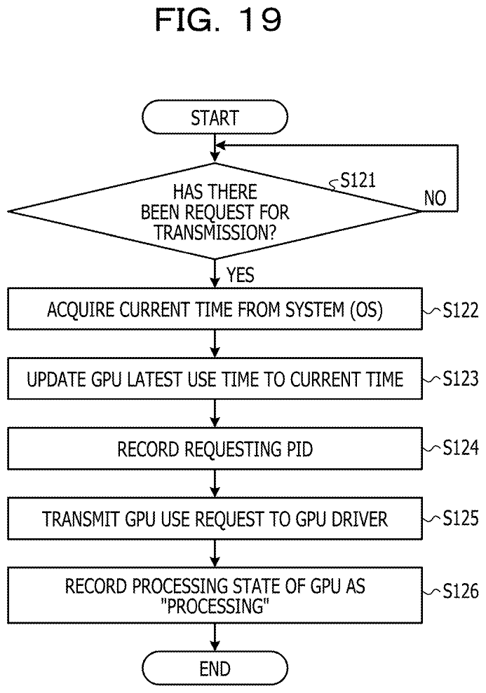

FIG. 19 is a diagram illustrating an example of a flowchart of use request transmission processing according to the third embodiment. As illustrated in FIG. 19, the use request transmission unit 126B determines whether there has been a request for transmission of a GPU use request (step S121). When it is determined that there has been no request for transmission of a GPU use request (No in step S121), the use request transmission unit 126B repeats the determination step until there is a transmission request.

On the other hand, when it is determined that there has been a request for transmission of a GPU use request (Yes in step S121), the use request transmission unit 126B acquires the current time from the system (OS) (step S122). The use request transmission unit 126B updates the GPU latest use time to the current time (step S123). The use request transmission unit 126B records the requesting PID in association with the GPU latest use time (step S124).

The use request transmission unit 126B transmits the GPU use request to the GPU driver 13 (step S125). The use request transmission unit 126B records the processing state of GPU as “processing” (step S126). The use request transmission unit 126B ends the use request transmission processing.

[Flowchart of Processing Result Transmission Destination Determination Processing]

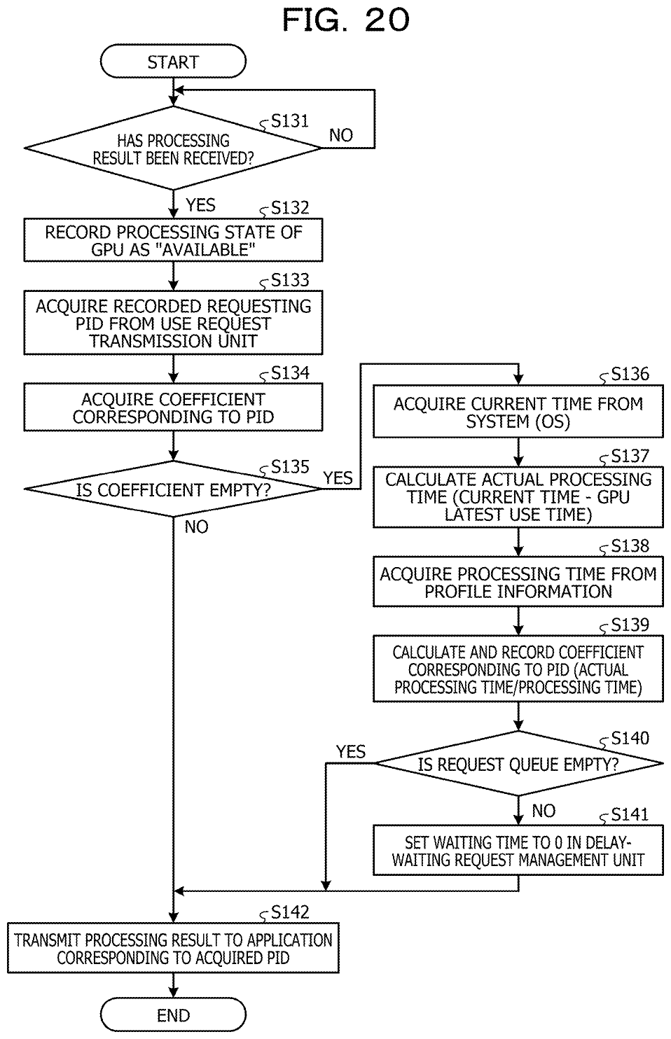

FIG. 20 is a diagram illustrating an example of a flowchart of processing result transmission destination determination processing according to the third embodiment. As illustrated in FIG. 20, the processing result transmission destination determination unit 128B determines whether a processing result has been received (step S131). When it is determined that the processing result has not been received (No in step S131), the processing result transmission destination determination unit 128B repeats the determination step until the processing result is received.

On the other hand, when it is determined that the processing result has been received (Yes in step S131), the processing result transmission destination determination unit 128B records the processing state of GPU as “available” (step S132). The processing result transmission destination determination unit 128B acquires the recorded requesting PID from the use request transmission unit 126B (step S133). The processing result transmission destination determination unit 128B acquires, from the profile information 15B, the coefficient corresponding to the acquired PID (step S134).

Next, the processing result transmission destination determination unit 128B determines whether coefficient is empty (step S135). When it is determined that coefficient is empty (Yes in step S135), the processing result transmission destination determination unit 128B acquires the current time from the system (OS) (step S136). The processing result transmission destination determination unit 128B calculates a value obtained by subtracting the GPU latest use time from the current time as the actual processing time (step S137).

The processing result transmission destination determination unit 128B acquires the processing time from the profile information 15B (step S138). The processing result transmission destination determination unit 128B records (actual processing time/processing time) in the profile information 15B as the coefficient corresponding to the PID (step S139).

The processing result transmission destination determination unit 128B determines whether the request queue is empty (step S140). When it is determined that the request queue is empty (Yes in step S140), the processing result transmission destination determination unit 128B proceeds to step S142.

On the other hand, when it is determined that the request queue is not empty (No in step S140), the processing result transmission destination determination unit 128B sets the waiting time to 0 in the delay-waiting request management unit 124B to immediately start the next request (step S141). The processing result transmission destination determination unit 128B proceeds to step S142.

In step S142, the processing result transmission destination determination unit 128B transmits the processing result to the application (inference process 11) corresponding to the acquired PID (step S142). The processing result transmission destination determination unit 128B ends the processing result transmission destination determination processing.

[Use of Multiple Control]

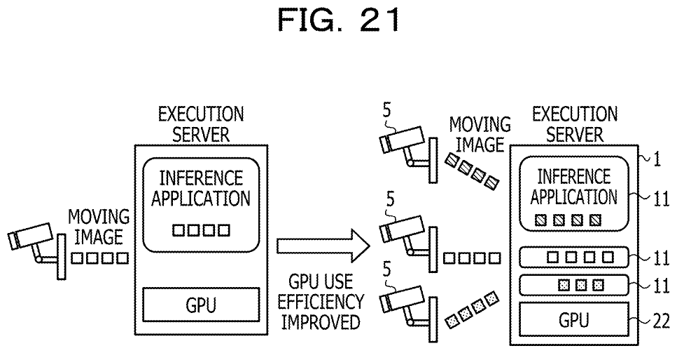

FIG. 21 is a diagram illustrating an example of use of multiple control according to the first to third embodiments. As illustrated on the left side in FIG. 21, in the related art, one GPU processes moving images (videos) transferred from one camera. With multiple control according to the first to third embodiments, as illustrated on the right side in FIG. 21, the execution server 1 may process moving images (videos) transferred from a plurality of cameras with one GPU 22. For example, when a plurality of inference applications (inference processes) 11 are executed at close timings, the execution server 1 delays the start of a subsequent inference application 11 by a threshold or more, the threshold being the processing time of processing in the inference application 11 having a large influence on processing time when executed in an overlapping manner. Thus, even when one GPU 22 executes a plurality of inference applications 11 in an overlapping manner, the execution server 1 may suppress an increase in processing time due to overlapping execution of processes.

### Effects of Third Embodiment

As described above, in the third embodiment, when processes of a plurality of applications use the same algorithm, the execution server 1 sets, as the threshold, a value obtained by measuring the processing time of the first step with the first GPU. The execution server 1 further records, in the profile information 15B, the total processing time of the process of any application executed with the first GPU. When a process is executed with the second GPU different from the first GPU, the execution server 1 performs control such that the first process of an application does not overlap the process of another application, and measures the total processing time of the process. The execution server 1 calculates a ratio between the total processing time stored in the profile information 15B and the measured total processing time, and uses, as a new threshold, a value obtained by multiplying the threshold by the calculated ratio. With such a configuration, even when the GPU that executes a process is changed, the execution server 1 may suppress an increase in processing time due to overlapping execution.

### OTHERS

In the third embodiment, description is given for multiple control performed by the execution server 1 when a plurality of inference processes 11 use the same algorithm. However, the execution server 1 may also perform multiple control when a plurality of inference processes 11 use different algorithms. For example, when processes of a plurality of applications use different algorithms, the execution server 1 measures the total processing time of the process of an application executed with the first GPU for each algorithm, and records the total processing time in the profile information 15B. When a process is executed with the second GPU different from the first GPU, the execution server 1 performs control such that the first process of an application does not overlap the process of another application, and measures the total processing time of the process for each algorithm. The execution server 1 calculates a ratio (coefficient) for each algorithm from the total processing time for each algorithm stored in the profile information 15B and the measured total processing time for each algorithm, and calculates a new threshold using the calculated ratio for each algorithm and the threshold. The execution server 1 may calculate a waiting time of the corresponding inference process 11 by using the new threshold corresponding to the algorithm. Thus, even when a plurality of inference processes 11 use different algorithms and the GPU that executes a process is changed, the execution server 1 may suppress an increase in processing time due to overlapping execution.

Each component of the GPU use control unit 12 included in the execution server 1 illustrated in the drawings does not necessarily have to be physically configured as illustrated in the drawings. For example, specific forms of separation and integration of each device are not limited to those illustrated in the drawings, and all or a part thereof may be functionally or physically separated and integrated in any unit depending on various loads, usage states, and the like. For example, the reading unit 122 and the delay execution determination unit 123 may be integrated as one unit. The delay-waiting request management unit 124 may be separated into a waiting unit that causes a GPU use request to wait for a set waiting time and a setting unit that calculates and sets a waiting time for the next GPU use request. A storage unit (not illustrated) that stores the profile information 15 and the like may be coupled via a network as an external device of the execution server 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a multiple control program that causes at least one computer to execute a process, the process comprising:
storing a processing time of a first step in processes of a plurality of applications as a first threshold in a storage unit when the processes are executed in an overlapping manner; and
when receiving an execution request from a subsequent application during execution of a process of the plurality of applications, delaying start of a process of the subsequent application by the first threshold or more from start of a process of a preceding application being executed.

2. The non-transitory computer-readable storage medium according to claim 1, wherein the delaying includes delaying by a value obtained by subtracting a time of a timing of the execution request from a value obtained by adding the first threshold to a start time of the preceding application, or more.

3. The non-transitory computer-readable storage medium according to claim 1, wherein the storing includes storing a value obtained by measuring processing time of the first step as a second threshold when the processes use a same algorithm.

4. The non-transitory computer-readable storage medium according to claim 3, wherein
the storing includes storing first total processing time of a process of the plurality of applications executed with a first GPU in the storage unit, wherein
the process further comprising:
when a process is executed with a second GPU different from the first GPU, determining order of processes so that a first process of an application does not overlap a process of another application,
acquiring second total processing time of a process,
acquiring a ratio between the first total processing time and the second total processing time, and
determining a third threshold by multiplying the second threshold by the ratio.

5. The non-transitory computer-readable storage medium according to claim 1, wherein
the storing includes storing processing time of the first step and processing time of a second step before the first step for each algorithm of a plurality of algorithms in the storage unit when the processes use the plurality of algorithms, wherein
the process further comprising
acquiring a fourth threshold by calculating from processing time of the first step and processing time of the second step corresponding to an algorithm in a process of the preceding application and processing time of the first step corresponding to an algorithm in a process of the subsequent application, wherein
the delaying includes delaying start of the process of the subsequent application from start of the process of the preceding application by the fourth threshold or more.

6. The non-transitory computer-readable storage medium according to claim 5, wherein
the storing includes storing third total processing time of a process of the plurality of applications executed with a first GPU for each algorithm of the plurality of algorithms in the storage unit, wherein
the process further comprising:
when a process is executed with a second GPU different from the first GPU, determining order of processes so that a first process of an application does not overlap a process of another application,
acquiring fourth total processing time of a process,
acquiring a ratio between the third total processing time and the fourth total processing time for each algorithm of the plurality of the algorithm, and
determining a fifth threshold by multiplying the fourth threshold by the ratio for each algorithm of the plurality of the algorithm.

7. The non-transitory computer-readable storage medium according to claim 1, wherein processing of the first step is convolution processing when the application is an inference application related to a video.

8. The non-transitory computer-readable storage medium according to claim 1, wherein processes of the plurality of applications are inference using a GPU.

9. An information processing apparatus comprising:
one or more memories; and
one or more processors coupled to the one or more memories and the one or more processors configured to
store a processing time of a first step in processes of a plurality of applications as a first threshold in the one or more memories when the processes are executed in an overlapping manner, and
when receiving an execution request from a subsequent application during execution of a process of the plurality of applications, delay start of a process of the subsequent application by the first threshold or more from start of a process of a preceding application being executed.

10. The information processing apparatus according to claim 9, wherein the one or more processors further configured to
delay by a value obtained by subtracting a time of a timing of the execution request from a value obtained by adding the first threshold to a start time of the preceding application, or more.

11. The information processing apparatus according to claim 9, wherein the one or more processors further configured to
store a value obtained by measuring processing time of the first step as a second threshold when the processes use a same algorithm.

12. The information processing apparatus according to claim 11, wherein the one or more processors further configured to
store first total processing time of a process of the plurality of applications executed with a first GPU in the one or more memories,
when a process is executed with a second GPU different from the first GPU, determine order of processes so that a first process of an application does not overlap a process of another application,
acquire second total processing time of a process,
acquire a ratio between the first total processing time and the second total processing time, and
determine a third threshold by multiplying the second threshold by the ratio.

13. The information processing apparatus according to claim 9, wherein the one or more processors further configured to
store processing time of the first step and processing time of a second step before the first step for each algorithm of a plurality of algorithms in the one or more memories when the processes use the plurality of algorithms,
acquire a fourth threshold by calculating from processing time of the first step and processing time of the second step corresponding to an algorithm in a process of the preceding application and processing time of the first step corresponding to an algorithm in a process of the subsequent application,
delay start of the process of the subsequent application from start of the process of the preceding application by the fourth threshold or more.

14. The information processing apparatus according to claim 13, wherein the one or more processors further configured to
store third total processing time of a process of the plurality of applications executed with a first GPU for each algorithm of the plurality of algorithms in the one or more memories,
when a process is executed with a second GPU different from the first GPU, determine order of processes so that a first process of an application does not overlap a process of another application,
acquire fourth total processing time of a process,
acquire a ratio between the third total processing time and the fourth total processing time for each algorithm of the plurality of the algorithm, and
determine a fifth threshold by multiplying the fourth threshold by the ratio for each algorithm of the plurality of the algorithm.

15. A multiple control method for a computer to execute a process comprising:
storing a processing time of a first step in processes of a plurality of applications as a first threshold in a storage unit when the processes are executed in an overlapping manner; and
when receiving an execution request from a subsequent application during execution of a process of the plurality of applications, delaying start of a process of the subsequent application by the first threshold or more from start of a process of a preceding application being executed.
